(19) United States
(12) Patent Application Publication
(10) Pub. No.: US 2003/0058649 A1
(43) Pub. Date: Mar. 27, 2003

(54) Lampshade mounting structure

(76) Inventor: Frank Chen, Taipei (TW)

Correspondence Address: Frank Chen, P.O. Box 26-757, Taipei, 106, TW

(21) Appl. No.: 09/967,293

(22) Filed: Sep. 27, 2001

(51) Int. Cl. F21V 1/00

(52) U.S. Cl. 362/282; 362/353

(57) ABSTRACT

A lampshade mounting structure includes a hollow conical lampshade, the lampshade having a mounting hole, a mounting socket, the mounting socket having a smoothly curved mounting flange attached to the outside wall of the lampshade around the mounting hole, a connector adapted to connect the lampshade to a support arm, the connector having a tubular shank inserted through the mounting socket, a threaded neck at one end of the shank, and an expanded coupling portion at the other end of the shank, a lock nut threaded onto the threaded neck to secure the connector and the mounting socket to the lampshade, and a packing plate coupled to the threaded neck of the connector and retained between the peripheral wall of the lampshade and the locknut.

### BACKGROUND OF THE INVENTION

The present invention relates to a lampshade mounting structure and, more particularly to such a lampshade mounting structure, which is easy to install and, which prevents the parts from loosening when adjusting the angular position of the conical lampshade.

FIG. 1 shows a lampshade mounting structure according to the prior art. This lampshade mounting structure 1a comprises a lampshade 10a, a mounting socket 11a, and a connector 12a. The lampshade 10a is a conical shell, having a mounting hole 14a at one side. The mounting socket 11a has an outwardly extended front mounting flange 15a riveted to the inside wall of the lampshade 10a around the mounting hole 14a. The mounting socket 11a holds a lamp holder 16a, which holds a lamp bulb 13a inside the lampshade 10a. The connector 12a has a tubular front mounting portion inserted into the mounting socket 11a and fixedly fastened thereto by a screw 17a, and a rear coupling portion 18a coupled to a support arm (not shown). When loosened the screw 17a, the user can rotate the lampshade 10a with the mounting socket 11a in the connector 12a through 360°. The coupling structure between the rear coupling portion of the connector 12a and the support arm enables the user to adjust the tilted angle of the lampshade. This lampshade mounting structure has drawbacks. Because the outwardly extended front mounting flange 15a of the mounting socket 11a is riveted to the smoothly curved inside wall of the lampshade 10a, the installation procedure of the mounting socket 11a is complicated. Frequently turning the lampshade 10a to adjust the angular position of the lampshade 10a tends to break the connecting area between the mounting socket 11a and the lampshade 10a, thereby causing the lampshade 10a to vibrate on the mounting socket 11a. Further, the lampshade 10a becomes hot a certain time after the lamp bulb 13a has been turned on, and the user's hand may be burned when touching the lampshade 10a in order to adjust the angular position of the lampshade 10a.

### SUMMARY OF THE INVENTION

The present invention has been accomplished to provide a lampshade mounting structure, which eliminates the aforesaid drawbacks. It is one object of the present invention to provide a lampshade mounting structure, which prevents loosening of the parts when adjusting the angular position of the lampshade. It is another object of the present invention to provide a lampshade mounting structure, which prevents the user from been scalded with the heat of the lamp bulb when adjusting the angular position of the lampshade.

According to one aspect of the present invention, the lampshade mounting structure comprises a hollow conical lampshade, the lampshade having a mounting hole, a mounting socket, the mounting socket having a smoothly curved mounting flange attached to the outside wall of the lampshade around the mounting hole, a connector adapted to connect the lampshade to a support arm, the connector having a tubular shank inserted through the mounting socket, a threaded neck at one end of the shank, and an expanded coupling portion at the other end of the shank, a lock nut threaded onto the threaded neck to secure the connector and the mounting socket to the lampshade, and a packing plate coupled to the threaded neck of the connector and retained between the peripheral wall of the lampshade and the locknut. According to another aspect of the present invention, a handle is backwardly extended from the rear side of the lampshade for the holding of the hand to adjust the angular position of the lampshade.

### BRIEF DESCRIPTION OF THE DRAWINGS

FIG. 1 is a sectional view of a prior art design.

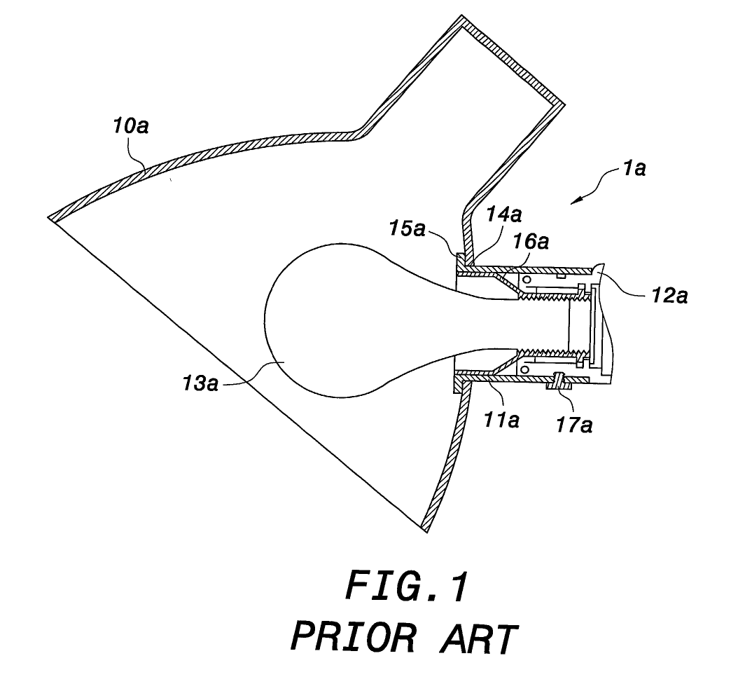

FIG. 2 is an exploded view of a lampshade mounting structure according to the present invention.

FIG. 3 is an elevational assembly view of FIG. 2.

FIG. 4 is a sectional plain view of FIG. 2.

FIG. 5 is an applied view of the present invention showing the connector connected to a support.

### DETAILED DESCRIPTION OF THE PREFERRED EMBODIMENT

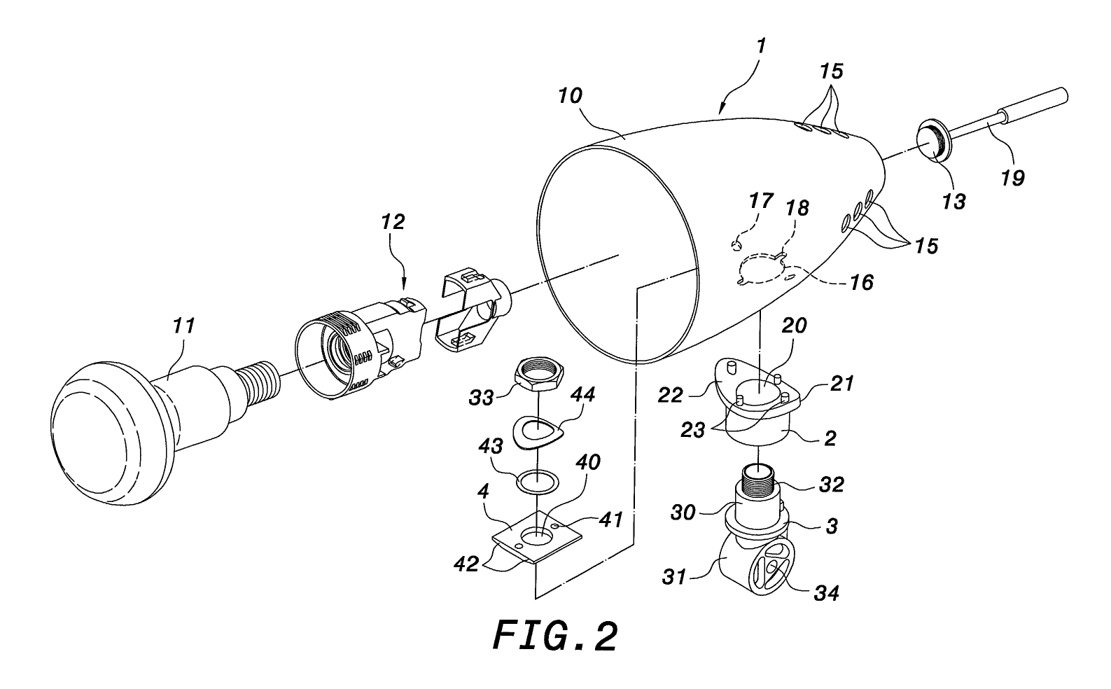

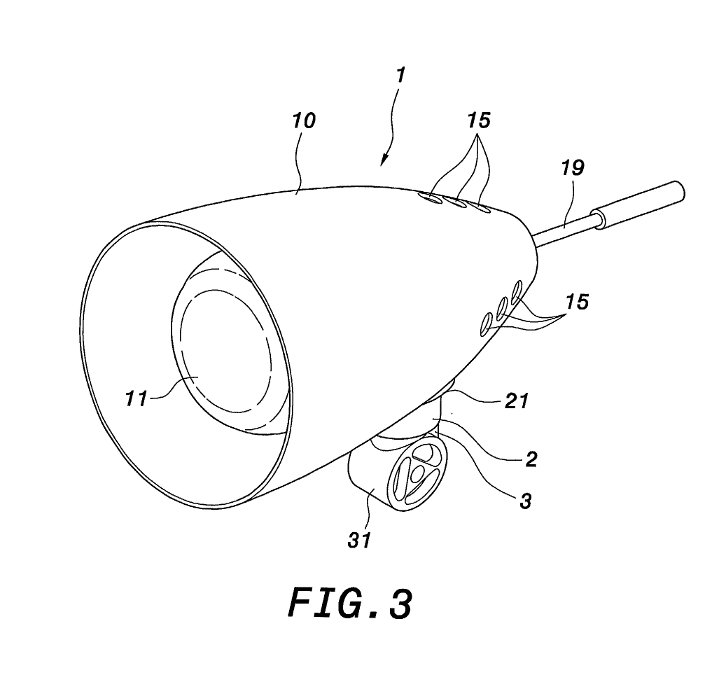

Referring to FIGS. 2, 3, and 4, the invention comprises a lampshade 1, a mounting socket 2, a connector 3, and a packing plate 4. The lampshade 1 is a hollow conical shell having a peripheral wall 10 smoothly curved from the front side toward the rear side. The front side of the lampshade 1 is an open side through which a lamp bulb 11 and a lamp holder 12 are inserted into the inside of the lampshade 1.

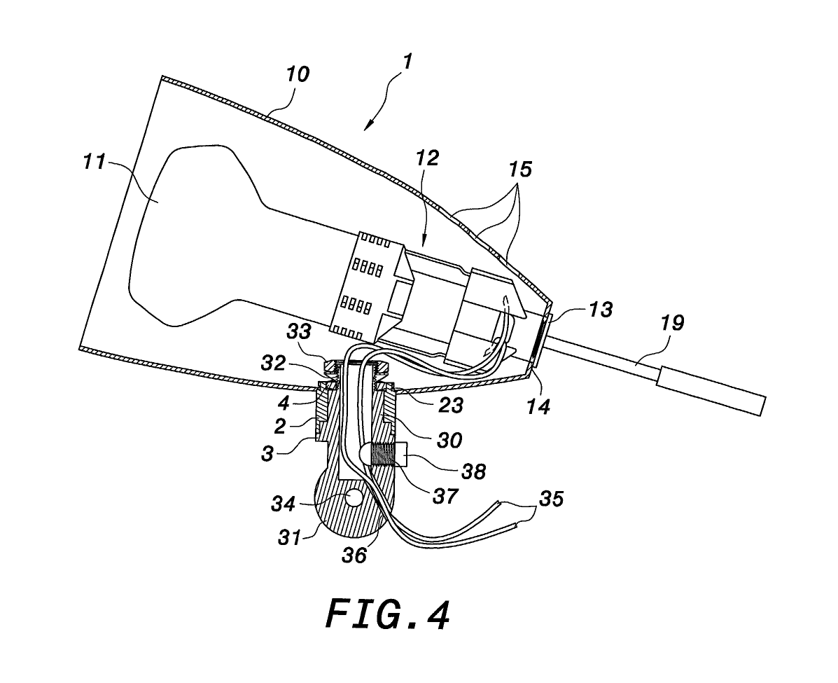

The lampshade 1 has a through hole 14 in the rear side (see FIG. 4). A screw 13 is mounted in the through hole 14 to fixedly secure the lamp holder 12 to the inside of the lampshade 10. Alternatively, the screw 13 can be formed integral with the rear side of the lampshade 10 for the mounting of the lamp holder 12.

The peripheral wall 10 of the lampshade 1 has air vents 15 near the rear side through which outside cooling air passes through the inside space of the lampshade 10 to carry heat away from lamp bulb 1 and the lamp holder 12, a mounting hole 16, two notches 18 in communication with the mounting hole 16 at two opposite sides, and two pin holes 17 equally spaced from the notches 18 at two sides of the mounting hole 16.

The mounting socket 2 comprises a tubular body 20, a mounting flange 21 outwardly extended from the periphery of one end of the tubular body 20, and a plurality of locating pins 23 perpendicularly extended from the smoothly arched outer face 22 of the mounting flange 21 and respectively inserted into the notches 18 and pin holes 17 of the lampshade 1. The curvature of the smoothly arched outer face 22 of the mounting socket 2 fits the peripheral wall 10 of the lampshade 1.

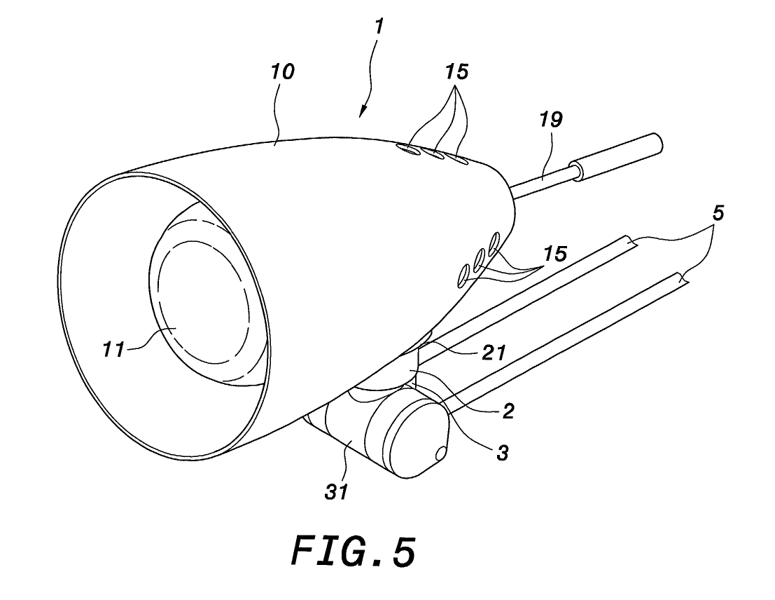

The connector 3 is shaped like a stepped tube having a tubular shank 20 inserted through the tubular body 20 of the mounting socket 2, a threaded neck 32 axially extended from one end of the tubular shank 30 and inserted through the mounting hole 16 into the inside of the lampshade 1, and a coupling block 31 integral with the other end of the tubular shank 30. The coupling block 31 has a transversely extended pivot hole 34 pivoted to a support arm 5 (see FIG. 5), for enabling the lampshade 1 to be tilted with the mounting socket 2 and the connector 3 relative to the support arm 5 to the desired tilted angle. Further, a lock nut 33 is threaded onto the threaded neck 32 to secure the connector 3 to the mounting socket 2 and the lampshade 1, for enabling the lampshade 1 to be turned with the mounting socket 2 on the connector 3 through 360°.

The packing plate 4 is a flat plate mounted inside the lampshade 1 and coupled to the mounting socket 2 and the connector 3, having a center through hole 40 coupled to the threaded neck 32 of the connector 3, two pin holes 41 respectively aimed at the notches 18 of the lampshade 1 and coupled to the corresponding locating pins 23 of the mounting socket 2, and two beveled bottom faces 42 disposed in contact with the inner surface of the peripheral wall 10 of the lampshade 1.

As indicated above, the smoothly arched outer face 22 of the mounting flange 21 of the mounting socket 2 is maintained in close contact with the outer surface of the peripheral wall 10 of the lampshade 1, and the lock nut 33 is threaded onto the threaded neck 32 of the connector 3 to secure the connector 3 and the mounting socket 2 to the lampshade 1. Therefore, the mounting socket 2 does not fall from the lampshade 1. Further, because the locating pins 23 of the mounting socket 2 are respectively engaged into the notches 18 and pin holes 17 of the lampshade 1 and the pin holes 41 of the packing plate 4, the lampshade 1 is prohibited from vibration relative to the mounting socket 2.

A handle 19 is provided at the rear side of the lampshade 1 through which the user can conveniently turn the lampshade 1 to the desired angular position. According to the present preferred embodiment, the handle 19 is fixedly connected to the screw 13. Alternatively, the handle 19 can be extended from the rear side of the lampshade 1. Because the handle 19 is disposed at a place far from the lamp bulb 11, the handle 19 is never hot.

Further, a gasket ring 43 is mounted on the threaded neck 32 of the connector 3 and retained between the lock nut 33 and the packing plate 4, and a spring washer 44 is mounted on the threaded neck 32 of the connector 3 and retained between the lock nut 33 and the gasket ring 43 (see FIGS. 2 and 4).

The connector 3 has a wire hole 36 for the passing of the electric wires 35 from the lamp holder 12, and a side screw hole 37 into which a holding down screw 38 is threaded to hold down the electric wires 35 in place (See FIG. 4).

A prototype of lampshade mounting structure has been constructed with the features of the annexed drawings of FIGS. 2˜5. The lampshade mounting structure functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A lampshade mounting structure comprising:
a lampshade, said lampshade having a peripheral wall smoothly curved from a front open side thereof toward a rear side thereof, and a mounting hole through said peripheral wall;
a mounting socket coupled to said lampshade, said mounting socket comprising a tubular body, a smoothly curved mounting flange outwardly extended from the periphery of one end of said tubular body and attached to the peripheral wall of said lampshade around the mounting hole of said lampshade;
a connector fastened to said lampshade to secure said mounting socket in place, said connector comprising a tubular shank inserted through the tubular body of said mounting socket, a neck axially extended from one end of said tubular shank and inserted through the mounting hole of said lampshade into the inside of said lampshade, and a coupling block integral with an opposite end of said tubular shank for coupling to a support arm;
a fastening element fastened to the neck of said connector to secure said connector to said mounting socket and said lampshade; and
a packing plate coupled to the neck of said connector and retained between the peripheral wall of said lampshade and said fastening element, said packing plate having a center through hole for the passing of the neck of said connector.

2. The lampshade mounting structure as claimed in claim 1 wherein said lampshade has a screw means fixedly provided at the rear side thereof for the mounting of a lamp holder and a lamp bulb in said lamp holder.

3. The lampshade mounting structure as claimed in claim 1 further comprising a handle backwardly extended from the rear side of said lampshade for the holding of the hand.

4. The lampshade mounting structure as claimed in claim 1 wherein the peripheral wall of said lampshade has air vents near the rear side of said lampshade.

5. The lampshade mounting structure as claimed in claim 1 wherein said lampshade has a plurality of pin holes around said mounting hole; said mounting flange of said mounting socket has a plurality of locating pins respectively engaged into the pin holes of said lampshade.

6. The lampshade mounting structure as claimed in claim 1 wherein said connector comprises a wire hole through which electric wires pass from the outside of said lampshade to the inside of said lampshade.

7. The lampshade mounting structure as claimed in claim 6 wherein said connector further comprises a screw hole in communication with said wire hole, and a holding down screw threaded into said screw hole and adapted to hold down electric wires in said wire hole.

8. The lampshade mounting structure as claimed in claim 1 wherein the neck of said connector is externally threaded, and said fastening element is a lock nut threaded onto the threaded neck of said connector.

9. The lampshade mounting structure as claimed in claim 1 wherein said coupling portion of said connector has a pivot hole for mounting.

10. The lampshade mounting structure as claimed in claim 1 wherein said packing plate has two beveled bottom faces disposed at a bottom side in contact with an inner surface of the peripheral wall of said lampshade.

11. The lampshade mounting structure as claimed in claim 1 further comprising a gasket ring mounted on the neck of said connector and retained between said fastening element and said packing plate, and a spring washer mounted on the neck of said connector and retained between said fastening element and said gasket ring.
